(19) United States
(12) Patent Application Publication
(10) Pub. No.: US 2026/0161950 A1
(43) Pub. Date: Jun. 11, 2026

(54) APPARATUS AND METHOD FOR GRAPH NEURAL NETWORK TRAINING USING AN ADAPTIVE PATH FILTER

(71) Applicant: Korea Institute of Energy Technology, Jeollanam-do (KR)

(72) Inventors: Chong Kwon KIM, Gwangju (KR); Tae Wook KO, Seoul (KR); Yoon Hyuk CHOI, Seoul (KR)

(21) Appl. No.: 19/408,372

(22) Filed: Dec. 4, 2025

(30) Foreign Application Priority Data
Dec. 6, 2024 (KR) 10-2024-0180912
Sep. 29, 2025 (KR) 10-2025-0140543

(51) Int. Cl. G06N 3/0895; G06N 3/042; G06N 3/048

(52) U.S. Cl. CPC G06N 3/0895; G06N 3/042; G06N 3/048

(57) ABSTRACT

The present invention relates to a graph neural network training apparatus using an adaptive path filter, the graph neural network training apparatus is configured to: predict a plurality of prediction nodes by respectively applying an adaptive path filter, which is a different type of path filter, to positive edge information and negative edge information constituting the edge information; calculate prediction reliabilities for the predicted plurality of prediction nodes, determine a reliability node set based on the calculated prediction reliabilities, and generate contrastive instances including positive contrastive instances and negative contrastive instances according to class classifications of nodes in the determined reliability node set; and train an edge prediction function by using the positive contrastive instances and the negative contrastive instances, and to predict edge information between the plurality of prediction nodes and the plurality of training nodes by the trained edge prediction function.

### CROSS-REFERENCE TO RELATED APPLICATION

This application claims priority from and the benefit of Korean Patent Application No. 10-2024-0180912 filed on Dec. 6, 2024, No. 10-2025-0140543 filed on Sep. 29, 2025, in the Korean Intellectual Property Office, the disclosure of which is incorporated herein by reference.

### BACKGROUND OF THE DISCLOSURE

### Field of the Disclosure

Example embodiments relate to an apparatus and method for graph neural network training using an adaptive path filter, and more particularly, to a graph neural network training technique of, for graph data for graph neural network training including homophilic subgraphs and heterophilic subgraphs, applying a low-pass filter to a positive subgraph including positive edge information and adaptively applying a high-pass filter to a negative subgraph including negative edge information so as to improve node classification performance using edge information.

### Description of the Related Art

A graph neural network (GNN), which is one type of deep learning, has made progress in graph representation learning by effectively extracting features from complex networks. In a GNN, message passing of node features across edges is performed through feature convolution. Message passing of node features across edges is generally divided into two main categories, spectral and spatial, and most models in these two categories aim to enhance node similarity. Spectral GNNs use low-pass filters that emphasize the propagation of generally low-frequency signals and attenuate high-frequency signals. In contrast, spatial GNNs typically aggregate features of topologically adjacent nodes to enhance similarity between node features. This approach has proven effective because it is generally well aligned with the intrinsic properties of real-world graphs that exhibit homophily. In homophilic subgraphs, connected nodes often share similar attributes and belong to the same class. Accordingly, conventional GNN training mainly exploits homophily by emphasizing feature smoothing.

However, an approach that excessively relies on amplifying node similarity has inherent limitations. The most critical issue is over-smoothing, in which node representations become indistinguishable after multiple layers of propagation. In addition, in heterophilic graphs where connected nodes tend to have different attributes, prioritizing node similarity can actually be problematic. In such cases, high-frequency features that are suppressed by low-pass filters may carry essential information. However, in GNNs according to the related art, there is a strong dependence on low-pass filters, and thus problems such as excessive smoothing of high-frequency signals and reduced utilization of such signals frequently arise. Recently, research has been initiated to address these limitations, and some work has focused on the problems faced by conventional GNNs on heterophilic graphs, thoroughly analyzing heterophilic properties and proposing innovative solutions. Graph filters have their own characteristics, and a low-pass filter tends to make node representations more similar after convolution. In contrast, a high-pass filter has the opposite effect, tending to make node representations less similar. Although advances in high-pass and adaptive path filtering methods have begun to address these issues, a comprehensive understanding of frequency characteristics and their optimal application still remains a challenging problem.

### SUMMARY

It is an object of the present invention to provide a graph neural network training apparatus and a graph neural network training method using an adaptive path filter which, for graph data for graph neural network training including homophilic subgraphs and heterophilic subgraphs, apply a low-pass filter to a subgraph including positive edge information and adaptively apply a high-pass filter to a subgraph including negative edge information so as to improve node classification performance using edge information.

It is another object of the present invention to provide a graph neural network training apparatus and a graph neural network training method using an adaptive path filter which, when connected nodes in graph data belong to the same class, use a low-pass filter, and when the connected nodes belong to different classes, use a high-pass filter so as to enhance heterogeneity, and apply different types of path filters having different frequency bands to positive edges and negative edges so as to effectively implement clustering according to classes.

It is still another object of the present invention to improve node classification performance and edge information prediction performance by simultaneously taking into account a parameter for adjusting a weight of high-frequency features and low-frequency features and a parameter for adjusting a weight of distances between nodes. In one embodiment of the present invention, a graph neural network training apparatus using an adaptive path filter may include an input unit configured to receive graph data including a plurality of training nodes and edge information connecting the plurality of training nodes, a node prediction unit configured to predict a plurality of prediction nodes by applying an adaptive path filter, which is a different type of path filter, respectively to positive edge information and negative edge information constituting the edge information, a contrastive learning unit configured to calculate prediction reliabilities for the predicted plurality of prediction nodes, determine a reliability node set based on the calculated prediction reliabilities, and generate contrastive instances including positive contrastive instances and negative contrastive instances according to class classifications of nodes in the determined reliability node set, and an edge prediction unit configured to train an edge prediction function by using the positive contrastive instances and the negative contrastive instances, and to predict edge information between the plurality of prediction nodes and the plurality of training nodes by the trained edge prediction function.

The graph neural network training apparatus using the adaptive path filter according to one embodiment of the present invention may further include an iterative learning unit configured to update the adaptive path filter by iteratively training such that edge information connecting a plurality of nodes in the graph data and node representations for the plurality of nodes are iteratively increased, by reflecting the predicted edge information and classification information of the plurality of prediction nodes into the graph data.

The node prediction unit may apply a low-pass filter to a positive subgraph constituted by the positive edge information representing edges connecting nodes having a same class with respect to classes of nodes, reduce distances between nodes such that the nodes belong to the same class, and predict any one node among the plurality of prediction nodes.

The node prediction unit may apply a high-pass filter to a negative subgraph constituted by the negative edge information representing edges connecting nodes having different classes with respect to the classes of the nodes, increase distances between nodes such that the nodes belong to different classes, and predict any one node among the plurality of prediction nodes.

The node prediction unit may calculate, in node prediction of a simple single-layer fully connected network using a softmax activation function, probabilities that the node prediction corresponds to any one of a first class and a second class, and determine a class of a prediction node based on the calculated probabilities.

The contrastive learning unit may calculate, for each of the predicted plurality of prediction nodes, a prediction reliability for a probability that the prediction node corresponds to any one of a first class and a second class, and determine the reliability node set based on the calculated prediction reliabilities.

The edge prediction unit may constitute a simple single-layer fully connected network using a sigmoid activation function for the positive contrastive instances and the negative contrastive instances, train the edge prediction function, and assign, for the plurality of prediction nodes, a label as either “0” or “1” according to whether each prediction node corresponds to any one contrastive instance among the positive contrastive instances and the negative contrastive instances.

The edge prediction unit may train the edge prediction function by summing a loss function value for node prediction results and a loss function value for the contrastive instances.

The edge prediction unit may update the edge information between the plurality of prediction nodes and the plurality of training nodes as the positive edge information when a prediction node and a training node correspond to a same class, and may update the edge information as the negative edge information when the prediction node and the training node correspond to different classes.

In one embodiment of the present invention, a graph neural network training method using an adaptive path filter may include: receiving, at an input unit, graph data including a plurality of training nodes and edge information connecting the plurality of training nodes; predicting, at a node prediction unit, a plurality of prediction nodes by applying an adaptive path filter, which is a different type of path filter, respectively to positive edge information and negative edge information constituting the edge information; calculating, at a contrastive learning unit, prediction reliabilities for the predicted plurality of prediction nodes, determining a reliability node set based on the calculated prediction reliabilities, and generating, in the determined reliability node set, contrastive instances including positive contrastive instances and negative contrastive instances according to class classifications of nodes; and training, at an edge prediction unit, an edge prediction function by using the positive contrastive instances and the negative contrastive instances, and predicting, by the trained edge prediction function, edge information between the plurality of prediction nodes and the plurality of training nodes.

The graph neural network training method using the adaptive path filter according to one embodiment of the present invention may further include updating the adaptive path filter, at an iterative learning unit, by iteratively training such that edge information connecting a plurality of nodes in the graph data and node representations for the plurality of nodes are iteratively increased, by reflecting the predicted edge information and classification information of the plurality of prediction nodes into the graph data.

In the method, predicting the plurality of prediction nodes by applying the adaptive path filter, which is a different type of path filter, respectively to the positive edge information and the negative edge information constituting the edge information, may include: applying a low-pass filter to a positive subgraph constituted by the positive edge information representing edges connecting nodes having a same class with respect to classes of nodes, reducing distances between nodes such that the nodes belong to the same class, and predicting any one node among the plurality of prediction nodes; applying a high-pass filter to a negative subgraph constituted by the negative edge information representing edges connecting nodes having different classes with respect to the classes of the nodes, increasing distances between nodes such that the nodes belong to different classes, and predicting any one node among the plurality of prediction nodes; and calculating, in node prediction of a simple single-layer fully connected network using a softmax activation function, probabilities that the node prediction corresponds to any one of a first class and a second class, and determining a class of a prediction node based on the calculated probabilities.

In the method, calculating the prediction reliabilities for the predicted plurality of prediction nodes, determining the reliability node set based on the calculated prediction reliabilities, and generating contrastive instances including the positive contrastive instances and the negative contrastive instances according to the class classifications of the nodes in the determined reliability node set, may include calculating, for each of the predicted plurality of prediction nodes, a prediction reliability for a probability that the prediction node corresponds to any one of a first class and a second class, and determining the reliability node set based on the calculated prediction reliabilities.

In the method, training the edge prediction function by using the positive contrastive instances and the negative contrastive instances, and predicting, by the trained edge prediction function, edge information between the plurality of prediction nodes and the plurality of training nodes, may include constituting a simple single-layer fully connected network using a sigmoid activation function for the positive contrastive instances and the negative contrastive instances, training the edge prediction function, and assigning, for the plurality of prediction nodes, a label as either “0” or “1” according to whether each prediction node corresponds to any one contrastive instance among the positive contrastive instances and the negative contrastive instances.

In the method, training the edge prediction function by using the positive contrastive instances and the negative contrastive instances, and predicting, by the trained edge prediction function, edge information between the plurality of prediction nodes and the plurality of training nodes, may include updating the edge information between the plurality of prediction nodes and the plurality of training nodes as the positive edge information when a prediction node and a training node correspond to a same class, and updating the edge information as the negative edge information when the prediction node and the training node correspond to different classes.

The present invention may provide a graph neural network training apparatus and a graph neural network training method using an adaptive path filter which, for graph data for graph neural network training including homophilic subgraphs and heterophilic subgraphs, apply a low-pass filter to a subgraph including positive edges and adaptively apply a high-pass filter to a subgraph including negative edges so as to improve node classification performance using edge information.

The present invention may provide a graph neural network training apparatus and a graph neural network training method using an adaptive path filter which, when connected nodes in graph data belong to the same class, use a low-pass filter, and when the connected nodes belong to different classes, use a high-pass filter so as to enhance heterogeneity, and which apply different band-pass filters to positive edges and negative edges so as to effectively implement clustering according to classes.

The present invention may improve node classification performance and edge information prediction performance by simultaneously taking into account a parameter for adjusting a weight of high-frequency features and low-frequency features and a parameter for adjusting a weight of distances between nodes.

The present invention may provide a graph neural network training apparatus and a graph neural network training method using an adaptive path filter which, by using nodes representing persons, objects, and media in graph data and edge information connecting the nodes, predict edge information connecting nodes belonging to the same class so as to more accurately classify and predict domains of interest, related domains, and less relevant domains.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a graph neural network training apparatus using an adaptive path filter according to an embodiment of the present invention.

FIG. 2 is a diagram illustrating an example of applying an adaptive path filter according to an embodiment of the present invention.

FIG. 3 is a diagram illustrating ranges of weight parameters of an adaptive path filter for node classification and edge information prediction of a graph neural network training apparatus according to an embodiment of the present invention.

FIG. 4 is a diagram illustrating node classification performance of a graph neural network training apparatus using an adaptive path filter according to an embodiment of the present invention.

FIG. 5 is a diagram illustrating a graph neural network training method using an adaptive path filter according to an embodiment of the present invention.

FIG. 6 is a diagram illustrating an algorithm applied to a graph neural network training apparatus using an adaptive path filter according to an embodiment of the present invention.

FIG. 7 is a diagram illustrating node classification performance of a graph neural network training apparatus using an adaptive path filter according to an embodiment of the present invention.

### DETAILED DESCRIPTION OF THE DISCLOSURE

The specific structural or functional descriptions of embodiments according to the concept of the present invention disclosed in the present specification are merely illustrated for the purpose of describing embodiments according to the concept of the present invention, and the embodiments according to the concept of the present invention may be implemented in various forms and are not limited to the embodiments described in the present specification.

Since embodiments according to the concept of the present invention may be modified in various ways and may have various forms, some embodiments are illustrated in the drawings and will be described in detail in the present specification. However, this is not intended to limit embodiments according to the concept of the present invention to particular disclosed forms, and it should be understood that they include substitutions, equivalents, and alternatives that fall within the spirit and scope of the present invention.

Terms such as first and second may be used to describe various components, but the components are not limited by the terms. The terms are used only for the purpose of distinguishing one component from another, and, for example, without departing from the scope of the concept of the present invention, a first component may be referred to as a second component, and similarly a second component may also be referred to as a first component.

When it is stated that one component is “connected” or “coupled” to another component, it should be understood that the one component may be directly connected or directly coupled to the other component, but that another component may be present therebetween. In contrast, when it is stated that one component is “directly connected” or “directly coupled” to another component, it should be understood that no other component is present therebetween. Expressions describing relationships between components, for example, “between,” “directly between,” or “directly adjacent to,” should be interpreted in the same manner.

The terminology used in the present specification is for the purpose of describing particular embodiments only and is not intended to limit the present invention. Unless clearly indicated otherwise by the context, the singular forms are intended to include the plural forms as well. In the present specification, terms such as “include” or “have” and the like are intended to specify that one or more stated features, numbers, steps, operations, components, parts, or combinations thereof are present, and are not intended to preclude the possibility that one or more other features, numbers, steps, operations, components, parts, or combinations thereof may also be present or added.

Unless otherwise defined, all terms used herein, including technical and scientific terms, have the same meaning as commonly understood by one of ordinary skill in the art to which the present invention pertains. Terms that are defined in generally used dictionaries are to be interpreted as having a meaning consistent with the contextual meaning of the related art, and, unless explicitly defined in the present specification, are not to be interpreted in an idealized or overly formal sense.

Hereinafter, embodiments will be described in detail with reference to the accompanying drawings. However, the scope of the patent application is not limited or restricted by these embodiments. The same reference numerals denote the same elements throughout the drawings.

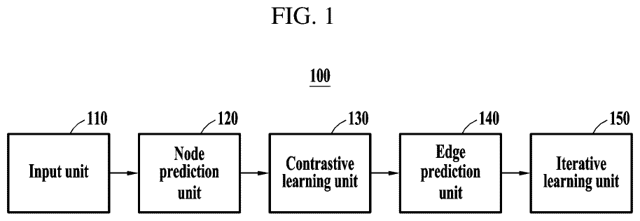

FIG. 1 is a diagram illustrating a graph neural network training apparatus using an adaptive path filter according to an embodiment of the present invention.

Referring to FIG. 1, a graph neural network training apparatus 100 using an adaptive path filter according to an embodiment of the present invention may include an input unit 110, a node prediction unit 120, a contrastive learning unit 130, an edge prediction unit 140, and an iterative learning unit 150.

In one example, the input unit 110 receives graph data including a plurality of training nodes and edge information connecting the plurality of training nodes.

That is, the input unit 110 processes graph data that are input to a graph neural network (GNN).

The graph data may include edge information constituted by positive edges and negative edges according to classes corresponding to relationships of respective nodes among a plurality of nodes.

According to an embodiment of the present invention, the node prediction unit 120 may predict a plurality of prediction nodes by respectively applying an adaptive path filter, which is a different type of path filter, to positive edge information and negative edge information constituting the edge information.

In one example, the node prediction unit 120 may apply a low-pass filter to a positive subgraph constituted by positive edge information representing edges connecting nodes having the same class with respect to classes of nodes, reduce distances between nodes such that the nodes belong to the same class, and predict any one node among the plurality of prediction nodes.

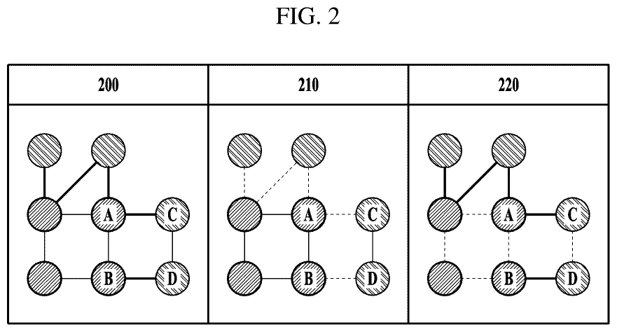

A distinction between the positive subgraph and a negative subgraph will be further described with reference to FIG. 2.

According to an embodiment of the present invention, the node prediction unit 120 may apply a high-pass filter to a negative subgraph constituted by negative edge information representing edges connecting nodes having different classes with respect to the classes of nodes, increase distances between nodes such that the nodes belong to different classes, and predict any one node among the plurality of prediction nodes.

In one example, the node prediction unit 120 may calculate, in node prediction of a simple single-layer fully connected network using a softmax activation function, probabilities that the node prediction corresponds to any one of a first class and a second class, and may determine a class of a prediction node based on the calculated probabilities.

The node prediction unit 120 uses a low-pass filter when connected nodes belong to the same class, and uses a high-pass filter when the connected nodes belong to different classes, thereby enhancing heterogeneity.

In addition, the node prediction unit 120 may apply the low-pass filter to the positive subgraph and may apply the high-pass filter to the negative subgraph so as to effectively cluster node representations belonging to the same class.

According to an embodiment of the present invention, a contrastive learning unit 130 may calculate prediction reliabilities for the predicted plurality of prediction nodes, determine a reliability node set based on the calculated prediction reliabilities, and generate contrastive instances including positive contrastive instances and negative contrastive instances according to class classifications of nodes in the determined reliability node set.

In one example, the contrastive learning unit 130 may calculate, for each of the predicted plurality of prediction nodes, a prediction reliability for a probability that the prediction node corresponds to any one of a first class and a second class, and may determine the reliability node set based on the calculated prediction reliabilities.

According to an embodiment of the present invention, an edge prediction unit 140 may train an edge prediction function by using the positive contrastive instances and the negative contrastive instances, and may predict edge information between the plurality of prediction nodes and the plurality of training nodes by the trained edge prediction function.

In one example, the edge prediction unit 140 may constitute a simple single-layer fully connected network using a sigmoid activation function for the positive contrastive instances and the negative contrastive instances, may train the edge prediction function, and may assign, for the plurality of prediction nodes, a label as either “0” or “1” according to whether each prediction node corresponds to any one contrastive instance among the positive contrastive instances and the negative contrastive instances.

That is, the edge prediction unit 140 may distinguish whether a node corresponds to a first class or a second class by assigning a label using the labels.

According to an embodiment of the present invention, the edge prediction unit 140 may train the edge prediction function by summing a loss function value for node prediction results and a loss function value for the contrastive instances.

In one example, the edge prediction unit 140 may update the edge information between the plurality of prediction nodes and the plurality of training nodes as the positive edge information when a prediction node and a training node correspond to a same class, and may update the edge information as the negative edge information when the prediction node and the training node correspond to different classes.

According to an embodiment of the present invention, an iterative learning unit 150 may perform iterative learning such that edge information connecting a plurality of nodes in the graph data and node representations for the plurality of nodes are iteratively increased, by reflecting the predicted edge information and classification information of the plurality of prediction nodes into the graph data.

A graph neural network training apparatus 100 using an adaptive path filter according to an embodiment of the present invention may implement recommendations based on graph data by classifying recommendation targets corresponding to nodes through inference of edge information.

For example, the recommendation targets may be node classification targets corresponding to domains of interest or related domains, based on nodes included in the graph data and edge information.

Therefore, the present invention may provide a graph neural network training apparatus and a graph neural network training method using an adaptive path filter which, for graph data for graph neural network training including homophilic subgraphs and heterophilic subgraphs, apply a low-pass filter to a subgraph including positive edges and adaptively apply a high-pass filter to a subgraph including negative edges so as to improve node classification performance using edge information.

The present invention may provide a graph neural network training apparatus and a graph neural network training method using an adaptive path filter which, by using nodes representing persons, objects, and media in graph data and edge information connecting the nodes, predict edge information connecting nodes belonging to the same class so as to more accurately classify and predict domains of interest, related domains, and less relevant domains.

FIG. 2 is a diagram illustrating an example of applying an adaptive path filter according to an embodiment of the present invention.

Referring to FIG. 2, graph data 200 represents entire graph data, graph data 210 represents a positive subgraph, and graph data 220 represents a negative subgraph.

In other words, the entire graph data is composed of nodes corresponding to different labels (or classes) and represents graph data including homophilic subgraphs and heterophilic subgraphs.

The graph data 210 is classified into nodes belonging to the same class, and, since the corresponding nodes belong to the same class, the graph data 210 is constituted as a positive subgraph by configuring positive edges between such nodes.

The graph data 210 is a partial graph including only positive edges by applying a low-pass filter and excluding negative edges, and illustrates a result of classifying nodes such that, after low-pass filtering, nodes that are not the same become farther apart and nodes that are the same become closer to each other.

Assuming that nodes are appropriately clustered by class, distances between nodes of the same class can be expected to be relatively uniform.

The graph data 220 is classified into nodes belonging to different classes, and, since the corresponding nodes belong to different classes, the graph data 220 is constituted as a negative subgraph by configuring negative edges between such nodes.

The graph data 220 is a partial graph including only negative edges by applying a high-pass filter and excluding positive edges, and illustrates a result of classifying nodes such that, after high-pass filtering, nodes that are not the same become farther apart.

Accordingly, when the high-pass filter is applied, distances between nodes representing different classes become larger, and node classification becomes more accurate.

In connection with the graph data 210 and the graph data 220, node representations are formed according to an equation for application of the adaptive path filter, which can be expressed as [Equation 1] below.

$$H = ( α {F}_{l} X + ( 1 - α ) {F}_{h} X ) \qquad [ Equation 1 ]$$

In Equation (1), H denotes node representations, a denotes a weight for filter application, F₁ denotes a low-pass filter, Fₕ denotes a high-pass filter, and X may denote training data.

Changes in distances according to the node representations can be expressed by Equations (2) and (3) below.

Equation (2) represents results related to distances between nodes in a case where the low-pass filter is applied, and Equation (3) represents results related to distances between nodes in a case where the high-pass filter is applied.

$$\begin{matrix}{𝒟}_{AC} \begin{matrix}< \\ \sim\end{matrix} {𝒟}_{AC}^{l} \begin{matrix}< \\ \sim\end{matrix} \vert 1 + ϵ \vert {𝒟}_{AC} , \\ {𝒟}_{BD} \begin{matrix}< \\ \sim\end{matrix} {𝒟}_{BD}^{l} \begin{matrix}< \\ \sim\end{matrix} \vert 1 + ϵ \vert {𝒟}_{BD} .\end{matrix} \qquad [ Equation 2 ]$$

$$\begin{matrix}{𝒟}_{AB} \begin{matrix}< \\ \sim\end{matrix} {𝒟}_{AB}^{h} \begin{matrix}< \\ \sim\end{matrix} \vert 1 + ϵ \vert {𝒟}_{AB} , \\ {𝒟}_{CD} \begin{matrix}< \\ \sim\end{matrix} {𝒟}_{CD}^{h} \begin{matrix}< \\ \sim\end{matrix} \vert 1 + ϵ \vert {𝒟}_{CD} .\end{matrix} \qquad [ Equation 3 ]$$

In Equations (2) and (3), [symbol] denotes a distance between nodes, A, B, C, and D denote individual nodes, 1 denotes a low-pass filter, h denotes a high-pass filter, and λ may denote a parameter for applying the adaptive path filter. When λ has a value between 0 and 1, nodes connected by positive edges may be set to tend to become closer to each other after low-pass filtering.

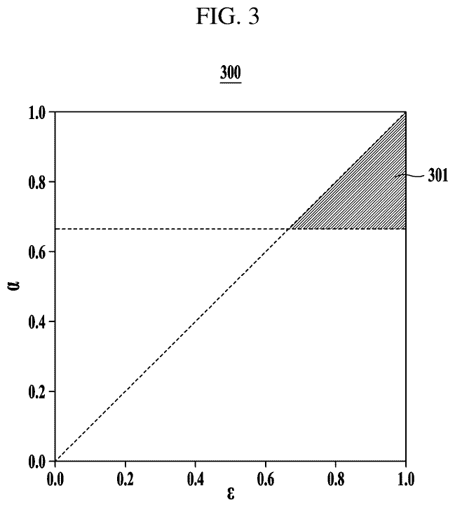

FIG. 3 is a diagram illustrating ranges of weight parameters of an adaptive path filter for node classification and edge information prediction of a graph neural network training apparatus according to an embodiment of the present invention.

FIG. 3 illustrates settings of parameters of weights for applying the adaptive path filter according to an embodiment of the present invention.

Referring to FIG. 3, a graph 300 illustrates a relationship between a parameter 2, which serves as a criterion for applying a low-pass filter to distances between nodes so as to set a lower bound of distances between nodes belonging to different classes to be greater than an upper bound of distances between nodes belonging to the same class in order to more clearly distinguish nodes of different classes from nodes of the same class, and a parameter α, which is a weight parameter for the low-pass filter and the high-pass filter.

The graph 300 shows that node classification accuracy is improved when the parameter λ and the parameter α are set to values located in a shaded region 301. Preferably, the parameter λ and the parameter α are located between 0.6 and 0.8, which exhibits high effectiveness in terms of node classification accuracy.

As a result, when 2 has a value between 0 and 1, nodes connected by positive edges may be set to tend to become closer to each other after low-pass filtering. Conversely, for nodes belonging to different classes, distances between the nodes increase.

The parameter α determines a balance between a high-pass filter representation and a low-pass filter representation, and when the low-pass filter representation is more advantageous for downstream tasks, α becomes closer to 1. In particular, even in heterogeneous datasets, the value of α is maintained at 0.6 or higher, which indicates the importance of the low-pass filter representation.

In addition, the present model assigns appropriate weights trained on a dataset so as to exploit advantages of both filters and provide superior performance.

The graph 300 shows conditions of the parameters 2 and a required for the adaptive path filter to operate as expected and to cluster nodes of the same class closer together than nodes of different classes.

In real datasets, most values of a are greater than 0.5 as described above, and even when 2 is set to be greater than 0.3, the filter can still operate properly.

Distances between nodes belonging to different classes are updated to be at least 0.8 times a minimum initial value, and thus the proposed adaptive path filter can be easily applied to most real graphs and can satisfy our design objective.

The present invention may improve node classification performance and edge information prediction performance by simultaneously taking into account a parameter for adjusting a weight of high-frequency features and low-frequency features and a parameter for adjusting a weight of distances between nodes.

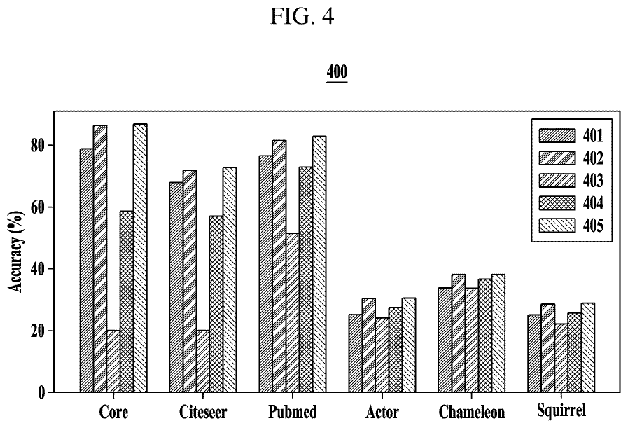

FIG. 4 is a diagram illustrating node classification performance of a graph neural network training apparatus using an adaptive path filter according to an embodiment of the present invention.

FIG. 4 illustrates that node classification performance is improved by adaptively applying a low-pass filter and a high-pass filter to graph data in connection with node classification performance of the graph neural network training apparatus using an adaptive path filter according to an embodiment of the present invention.

Referring to FIG. 4, a graph 400 represents node classification performance using edge information by the graph neural network training apparatus according to an embodiment of the present invention.

The graph 400 shows data 401, data 402, data 403, data 404, and data 405, and the data 405 represents a case in which the adaptive path filter is applied in the graph neural network training apparatus according to an embodiment of the present invention.

The data 401 represents a case in which a low-pass filter is applied to a positive subgraph, the data 402 represents a case in which a high-pass filter is applied to an entire graph, the data 403 represents a case in which a high-pass filter is applied to a negative subgraph, and the data 404 represents a case in which a low-pass filter is applied to the entire graph.

The data 401 to the data 405 represent node classification results for various graph datasets including “Cora.”

The data 401 and the data 403 are superior in terms of accuracy, and the data 405 according to an embodiment of the present invention also shows excellent classification accuracy.

The data 405 is a result applied to an entire dataset, and it can be seen that the accuracy is also high for heterogeneous subgraph data.

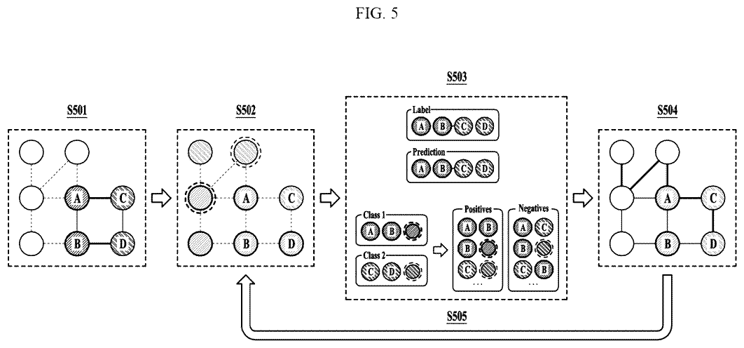

FIG. 5 is a diagram illustrating a graph neural network training method using an adaptive path filter according to an embodiment of the present invention.

Referring to FIG. 5, in step S501, a graph neural network training method using an adaptive path filter according to an embodiment of the present invention processes input data for graph data including a plurality of training nodes and edge information connecting the plurality of training nodes.

In the input data, a graph including a structure and training nodes {A, B, C, D} is provided, and induced positive (+) and negative (−) edges are respectively indicated by solid lines and bold lines.

In the input data, initial edge information is limited.

In step S502, the graph neural network training method using an adaptive path filter according to an embodiment of the present invention predicts node classification by using an adaptive path filter with the edge information.

The graph neural network training method using an adaptive path filter according to an embodiment of the present invention predicts a plurality of prediction nodes by respectively applying an adaptive path filter, which is a different type of path filter, to positive edge information and negative edge information constituting the edge information.

Node prediction is performed by using the proposed adaptive path filter, and nodes indicated by double circles may represent nodes having high reliability.

In step S503, the graph neural network training method using an adaptive path filter according to an embodiment of the present invention creates a virtual ground-truth set by using high-reliability nodes and generates contrastive instances.

The graph neural network training method using an adaptive path filter according to an embodiment of the present invention calculates prediction reliabilities for the predicted plurality of prediction nodes, determines a reliability node set based on the calculated prediction reliabilities, and may generate contrastive instances including positive contrastive instances and negative contrastive instances according to class classifications of nodes in the determined reliability node set.

For example, in the reliability node set, the virtual ground-truth set may be a pseudo set.

In summary, classes for node prediction results are classified into a first class and a second class, and the positive contrastive instances and the negative contrastive instances for the classified classes are used to train an edge function.

In step S504, the graph neural network training method using an adaptive path filter according to an embodiment of the present invention predicts edge information by using a trained edge prediction function.

That is, the graph neural network training method using an adaptive path filter according to an embodiment of the present invention trains an edge prediction function by using the positive contrastive instances and the negative contrastive instances, and may predict edge information between the plurality of prediction nodes and the plurality of training nodes by the trained edge prediction function.

In step S505, the graph neural network training method using an adaptive path filter according to an embodiment of the present invention updates the adaptive path filter by reflecting the predicted edge information for subsequent nodes.

That is, the graph neural network training method using an adaptive path filter according to an embodiment of the present invention may update the adaptive path filter by reflecting the predicted edge information and classification information of the plurality of prediction nodes into the graph data, and performing iterative learning such that edge information connecting a plurality of nodes in the graph data and node representations for the plurality of nodes are iteratively increased.

Iterative learning according to a repetitive approach promotes mutual improvement between node representations and edge information, thereby creating a synergistic effect.

The updated node representations (node classification and edge information between nodes) achieve higher accuracy in a high-reliability node set, and accurate edge updates can be performed.

Accordingly, by providing accurate edge information, subsequent iterative learning can proceed smoothly.

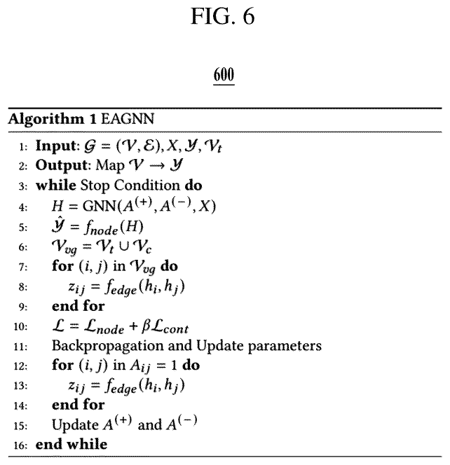

FIG. 6 is a diagram illustrating an algorithm applied to a graph neural network training apparatus using an adaptive path filter according to an embodiment of the present invention.

Referring to FIG. 6, an algorithm 600 receives graph data G as input and outputs classification results.

At “4:”, a GNN is performed by applying the adaptive path filter, and at “5:”, nodes are classified.

At “6:”, a virtual ground-truth set having high reliability is defined as a sum of a virtual truth set and contrastive instances according to a softmax output function.

At “8:”, edge information is predicted by an edge function, and after repetition, at “10:”, the process is refined by using a loss function, and at “13:”, edge information is predicted by using the updated edge function, and at “15:”, the adaptive path filter is updated.

A synergistic effect is created by a repetitive approach that promotes mutual improvement between node representations and edge information.

With respect to the update, the update of the adaptive path filter at “15:” may be defined as in Equation (4) below.

$$\begin{matrix}{A}_{ij}^{( + )} = \{ \begin{matrix}1 , & if {f}_{edge} ( {h}_{i} , {h}_{j} ) \geq 0.5 and {A}_{ij} = 1 \\ 0 , & otherwise\end{matrix} , \\ {A}_{ij}^{( - )} = \{ \begin{matrix}1 , & if {f}_{edge} ( {h}_{i} , {h}_{j} ) < 0.5 and {A}_{ij} = 1 \\ 0 , & otherwise\end{matrix} .\end{matrix} \qquad [ Equation 4 ]$$

In Equation (4), ƒ_{edge} denotes an edge prediction function and represents an update of learned edge information, and Aᵢⱼ(+) and Aᵢⱼ(−) may be updated by using edge information.

The effect of the iterative approach ensures appropriate application of the adaptive path filter and improves the accuracy of edge prediction.

In heterogeneous graph data including different classes, the node classification problem can be solved by adaptively applying a low-pass filter and a high-pass filter according to the edge information.

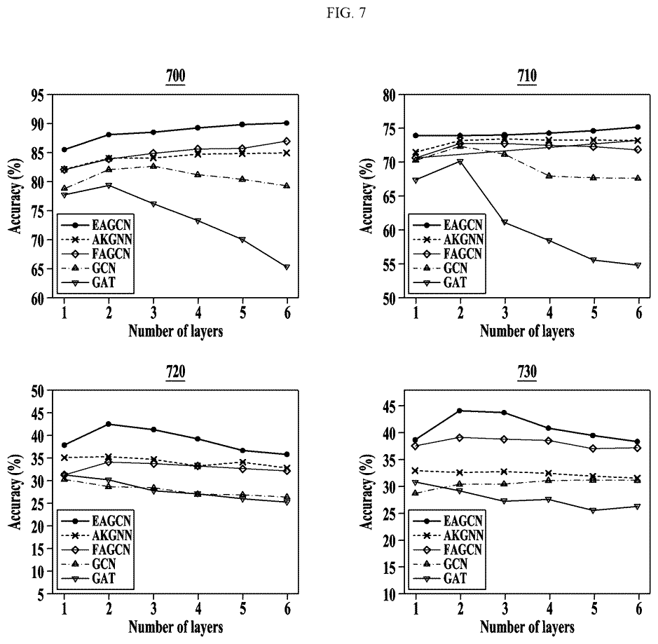

FIG. 7 is a diagram illustrating node classification performance of a graph neural network training apparatus using an adaptive path filter according to an embodiment of the present invention.

FIG. 7 illustrates node classification performance in terms of changes in classification accuracy according to a change in the number of layers when the graph neural network training apparatus using an adaptive path filter according to an embodiment of the present invention performs node classification.

Referring to FIG. 7, a graph 700, a graph 710, a graph 720, and a graph 730 show performance trends according to the number of layers.

In homophilic datasets, frequency-filter models (AKGNN, FAGCN, and EAGNN) consistently exhibit superior or competitive results at various depths. EAGNN, which corresponds to the present invention, demonstrates an ability to maintain node separation even at deeper layers (with the number of layers increasing), by enhancing similarity between node representations while preserving their distinctiveness as needed.

For example, deeper layers correspond to an increase in the number of layers from “1” to “6.”

In contrast, models relying on basic convolutional techniques (GCN, GAT) show degraded performance as depth increases.

However, in heterophilic datasets, EAGNN exhibits performance degradation as the number of layers increases.

At deeper layers, EAGNN depends more heavily on inferred edge information than at shallow layers.

In addition, repeatedly using incorrect convolution operations is likely to contribute to the performance degradation.

Despite this degradation, EAGNN still shows the best performance, and these experiments demonstrate that the proposed EAGNN effectively addresses the over-smoothing problem and remains effective.

Accordingly, the present invention may provide a graph neural network training apparatus and a graph neural network training method using an adaptive path filter which, when connected nodes in graph data belong to the same class, use a low-pass filter, and when the connected nodes belong to different classes, use a high-pass filter so as to enhance heterogeneity, and which apply different band-pass filters to positive edges and negative edges so as to effectively implement clustering according to classes.

The apparatuses described above may be implemented as hardware components, software components, and/or a combination of hardware components and software components. For example, the apparatuses and components described in the embodiments may be implemented by using one or more general-purpose computers or special-purpose computers, such as a processor, a controller, an arithmetic logic unit (ALU), a digital signal processor (DSP), a microcomputer, a field programmable array (FPA), a programmable logic unit (PLU), a microprocessor, or any other device capable of executing and responding to instructions. The processing device may execute an operating system (OS) and one or more software applications running on the operating system. In addition, the processing device may access, store, manipulate, process, and generate data in response to execution of software.

For ease of understanding, some descriptions assume that a single processing device is used, but it will be understood by those of ordinary skill in the art that the processing device may include a plurality of processing elements and/or a plurality of types of processing elements. For example, the processing device may include a plurality of processors, or one processor and one controller. Other processing configurations, such as a parallel processor, are also possible.

Software may include a computer program, code, instructions, or any combination of one or more of the foregoing, and may configure the processing device to operate in a desired manner or instruct the processing device, individually or collectively, to operate in a desired manner. The software and/or data may be embodied, permanently or temporarily, in any type of machine, component, physical device, virtual equipment, computer storage medium or device, or transmitted signal wave, so as to be interpreted by the processing device or to provide instructions or data to the processing device. The software may be distributed over computer systems connected by a network and may be stored or executed in a distributed manner. The software and data may be stored in one or more computer-readable recording media.

Although the embodiments have been described with reference to limited drawings as set forth above, various modifications and variations can be made from the foregoing disclosure by those of ordinary skill in the art. For example, the described techniques may be performed in an order different from that described, and/or components of the described systems, structures, apparatuses, and circuits may be combined or arranged in forms different from those described, or may be replaced or substituted with other components or equivalents, while still achieving appropriate results.

Accordingly, other implementations, other embodiments, and equivalents to the claims are also within the scope of the following claims.

What is claimed is:

1. A graph neural network training apparatus using an adaptive path filter, comprising:
an input unit configured to receive graph data including a plurality of training nodes and edge information connecting the plurality of training nodes;
a node prediction unit configured to predict a plurality of prediction nodes by applying an adaptive path filter, which is a different type of path filter, respectively to positive edge information and negative edge information constituting the edge information;
a contrastive learning unit configured to calculate prediction reliabilities for the predicted plurality of prediction nodes, determine a reliability node set based on the calculated prediction reliabilities, and generate contrastive instances including positive contrastive instances and negative contrastive instances according to class classifications of nodes in the determined reliability node set; and
an edge prediction unit configured to train an edge prediction function by using the positive contrastive instances and the negative contrastive instances, and to predict edge information between the plurality of prediction nodes and the plurality of training nodes by the trained edge prediction function.

2. The graph neural network training apparatus using the adaptive path filter of claim 1, further comprising:
an iterative learning unit configured to update the adaptive path filter by iteratively training such that edge information connecting a plurality of nodes in the graph data and node representations for the plurality of nodes are iteratively increased, by reflecting the predicted edge information and classification information of the plurality of prediction nodes into the graph data.

3. The graph neural network training apparatus using the adaptive path filter of claim 1, wherein
the node prediction unit is configured to apply a low-pass filter to a positive subgraph constituted by the positive edge information representing edges connecting nodes having a same class with respect to classes of nodes, to reduce distances between nodes such that the nodes belong to the same class, and to predict any one node among the plurality of prediction nodes.

4. The graph neural network training apparatus using the adaptive path filter of claim 3, wherein
the node prediction unit is configured to apply a high-pass filter to a negative subgraph constituted by the negative edge information representing edges connecting nodes having different classes with respect to the classes of the nodes, to increase distances between nodes such that the nodes belong to different classes, and to predict any one node among the plurality of prediction nodes.

5. The graph neural network training apparatus using the adaptive path filter of claim 4, wherein
the node prediction unit is configured to calculate, in node prediction of a simple single-layer fully connected network using a softmax activation function, probabilities that the node prediction corresponds to any one of a first class and a second class, and to determine a class of the prediction node based on the calculated probabilities.

6. The graph neural network training apparatus using the adaptive path filter of claim 1, wherein
the contrastive learning unit is configured to calculate, for each of the predicted plurality of prediction nodes, a prediction reliability for a probability that the prediction node corresponds to any one of a first class and a second class, and to determine the reliability node set based on the calculated prediction reliabilities.

7. The graph neural network training apparatus using the adaptive path filter of claim 1, wherein
the edge prediction unit is configured to constitute a simple single-layer fully connected network using a sigmoid activation function for the positive contrastive instances and the negative contrastive instances, to train the edge prediction function, and to assign, for the plurality of prediction nodes, a label as either “0” or “1” according to whether each prediction node corresponds to any one contrastive instance among the positive contrastive instances and the negative contrastive instances.

8. The graph neural network training apparatus using the adaptive path filter of claim 7, wherein
the edge prediction unit is configured to train the edge prediction function by summing a loss function value for node prediction results and a loss function value for the contrastive instances.

9. The graph neural network training apparatus using the adaptive path filter of claim 7, wherein
the edge prediction unit is configured to update the edge information between the plurality of prediction nodes and the plurality of training nodes as the positive edge information when a prediction node and a training node correspond to a same class, and to update the edge information as the negative edge information when the prediction node and the training node correspond to different classes.

10. A graph neural network training method using an adaptive path filter, comprising:
receiving, at an input unit, graph data including a plurality of training nodes and edge information connecting the plurality of training nodes;
predicting, at a node prediction unit, a plurality of prediction nodes by applying an adaptive path filter, which is a different type of path filter, respectively to positive edge information and negative edge information constituting the edge information;
calculating, at a contrastive learning unit, prediction reliabilities for the predicted plurality of prediction nodes, determining a reliability node set based on the calculated prediction reliabilities, and generating contrastive instances including positive contrastive instances and negative contrastive instances according to class classifications of nodes in the determined reliability node set; and
training, at an edge prediction unit, an edge prediction function by using the positive contrastive instances and the negative contrastive instances, and predicting, by the trained edge prediction function, edge information between the plurality of prediction nodes and the plurality of training nodes.

11. The graph neural network training method using the adaptive path filter of claim 10, further comprising:
updating the adaptive path filter, at an iterative learning unit, by iteratively training such that edge information connecting a plurality of nodes in the graph data and node representations for the plurality of nodes are iteratively increased, by reflecting predicted edge information and classification information of the plurality of prediction nodes into the graph data.

12. The graph neural network training method using the adaptive path filter of claim 10, wherein
predicting the plurality of prediction nodes by applying the adaptive path filter, which is a different type of path filter, respectively to the positive edge information and the negative edge information constituting the edge information, comprises:
applying a low-pass filter to a positive subgraph constituted by the positive edge information representing edges connecting nodes having a same class with respect to classes of nodes, reducing distances between nodes such that the nodes belong to the same class, and predicting any one node among the plurality of prediction nodes;
applying a high-pass filter to a negative subgraph constituted by the negative edge information representing edges connecting nodes having different classes with respect to the classes of the nodes, increasing distances between nodes such that the nodes belong to different classes, and predicting any one node among the plurality of prediction nodes; and
calculating, in node prediction of a simple single-layer fully connected network using a softmax activation function, probabilities that the node prediction corresponds to any one of a first class and a second class, and determining a class of a prediction node based on the calculated probabilities.

13. The graph neural network training method using the adaptive path filter of claim 10, wherein
calculating the prediction reliabilities for the predicted plurality of prediction nodes, determining the reliability node set based on the calculated prediction reliabilities, and generating contrastive instances including the positive contrastive instances and the negative contrastive instances according to the class classifications of the nodes in the determined reliability node set, comprises:
calculating, for each of the predicted plurality of prediction nodes, a prediction reliability for a probability that the prediction node corresponds to any one of a first class and a second class, and determining the reliability node set based on the calculated prediction reliabilities.

14. The graph neural network training method using the adaptive path filter of claim 10, wherein
training the edge prediction function by using the positive contrastive instances and the negative contrastive instances, and predicting, by the trained edge prediction function, edge information between the plurality of prediction nodes and the plurality of training nodes, comprises:
constituting a simple single-layer fully connected network using a sigmoid activation function for the positive contrastive instances and the negative contrastive instances, training the edge prediction function, and assigning, for the plurality of prediction nodes, a label as either “0” or “1” according to whether each prediction node corresponds to any one contrastive instance among the positive contrastive instances and the negative contrastive instances.

15. The graph neural network training method using the adaptive path filter of claim 10, wherein
training the edge prediction function by using the positive contrastive instances and the negative contrastive instances, and predicting, by the trained edge prediction function, edge information between the plurality of prediction nodes and the plurality of training nodes, comprises:
updating the edge information between the plurality of prediction nodes and the plurality of training nodes as the positive edge information when a prediction node and a training node correspond to a same class, and updating the edge information as the negative edge information when the prediction node and the training node correspond to different classes.
